(19) United States
(12) Patent Application Publication
(10) Pub. No.: US 2026/0081972 A1
(43) Pub. Date: Mar. 19, 2026

(54) THERMAL CAMERA DAISY CHAIN

(71) Applicant: Delta Thermal , Inc., Tucson, AZ (US)

(72) Inventor: Andrew Griffis, Tucson, AZ (US)

(21) Appl. No.: 19/401,833

(22) Filed: Nov. 26, 2025

Related U.S. Application Data
(63) Continuation-in-part of application No. 18/490,044, filed on Oct. 19, 2023, now Pat. No. 12,493,989.
Application No. 18/490,044 is a continuation-in-part of application No. 17/237,032, filed on Apr. 21, 2021, now Pat. No. 11,832,025.
Application No. 17/237,032 is a continuation-in-part of application No. 16/779,622, filed on Feb. 2, 2020, now Pat. No. 10,991,217.
(60) Provisional application No. 63/013,081, filed on Apr. 21, 2020.

(51) Int. Cl. H04L 67/12

(52) U.S. Cl. CPC H04L 67/12

(57) ABSTRACT

A data communication system. The system includes a hub device configured to generate an outgoing data signal and power, and receive an incoming data signal. The system further includes a transmission line operatively coupled to the hub device, configured to transmit the outgoing data signal, the incoming data signal, and the power simultaneously. The system further includes a plurality of devices operatively coupled along the transmission line in a daisy chain configuration such that an amount of power is delivered to each device, each device having a data transceiver configured to transmit an amount of the outgoing data signal and receive an amount of the incoming data signal.

### CROSS-REFERENCES TO RELATED APPLICATIONS

This application is a continuation-in part and claims benefit of U.S. patent application Ser. No. 18/490,044, filed Oct. 19, 2023, which is a continuation-in-part and claims benefit of U.S. patent application Ser. No. 17/237,032, filed Apr. 21, 2021, which is a non-provisional and claims benefit of U.S. Provisional Patent Application No. 63/013,081, filed Apr. 21, 2020, the specifications of which are incorporated herein in their entirety by reference.

U.S. patent application Ser. No. 17/237,032 is also a continuation-in-part and claims benefit of U.S. patent application Ser. No. 16/779,622, filed Feb. 2, 2020, the specification(s) of which are incorporated herein in their entirety by reference.

### BACKGROUND OF THE INVENTION

The proliferation of Internet of Things (IoT) devices, industrial sensor networks, and networked robotic systems has created an urgent need for communication infrastructure that combines high bandwidth, deterministic latency, physical security, and simplified installation. Traditional approaches to networking these distributed systems present fundamental tradeoffs that limit their applicability in demanding environments.

Conventional wireless communication systems-including WiFi (IEEE 802.11), Bluetooth Low Energy (BLE), Zigbee (IEEE 802.15.4), and other RF protocols-offer significant advantages in terms of device mobility, ease of installation, and elimination of complex wiring harnesses. However, these omnidirectional wireless systems suffer from critical weaknesses in industrial, medical, and security-sensitive applications. Electromagnetic interference from heavy machinery, variable frequency drives, switching power supplies, and other sources of EMI/RFI can render wireless communication unreliable or completely inoperative. The omnidirectional nature of radio propagation creates fundamental security vulnerabilities, as data signals cannot be physically contained, enabling over-the-air interception, injection attacks, and unauthorized network access. Furthermore, unpredictable multipath fading, interference from competing wireless networks, and the stochastic nature of wireless medium access control create non-deterministic latency characteristics unsuitable for time-critical control applications.

Conversely, traditional wired communication systems-whether industrial fieldbus protocols (CAN, Modbus, PROFIBUS), Ethernet-based approaches (PROFINET, EtherCAT), or proprietary serial interfaces-provide deterministic performance and physical security through signal containment. However, these systems impose substantial installation complexity and cost. Star topologies require home-run cables from each device to a central hub, resulting in massive cable bundles in large installations. Point-to-point wiring between devices creates exponentially increasing complexity as network size grows. Specialized industrial protocols often require expensive transceivers, lack compatibility with standard networking equipment, and provide limited bandwidth insufficient for modern high-resolution sensing applications such as thermal imaging or machine vision.

In specialized applications such as articulated robotic systems, the limitations of both approaches become acute. Robotic manipulators, gimbal systems, rotating machinery, and other multi-axis mechanisms require reliable transmission of power and high-bandwidth data across mechanical interfaces that undergo continuous motion. Traditional slip rings provide electrical continuity across rotating interfaces but suffer from brush wear, require regular maintenance, introduce electrical noise, exhibit high contact resistance, and have severe bandwidth limitations that preclude modern communication protocols. Wireless solutions avoid mechanical wear but reintroduce all the interference, security, and non-deterministic behavior problems inherent to omnidirectional RF transmission, while also facing challenges in maintaining reliable communication across moving metal structures.

In environments with limited or no access to conventional networking infrastructure-such as underground mining operations, subsea installations, or electromagnetically shielded facilities—the challenge intensifies further. These settings often have existing coaxial cable infrastructure originally installed for analog video distribution or other legacy systems, but lack modern high-bandwidth networking capabilities. Retrofitting such environments with new communication infrastructure requires substantial capital investment, operational disruption, and physical access that may be difficult or impossible to obtain.

Thus, there exists a need for a communication architecture that combines the bandwidth, protocol compatibility, and cost advantages of modern wireless standards with the reliability, security, and deterministic behavior of wired systems, while minimizing installation complexity and enabling deployment in electromagnetically hostile or mechanically dynamic environments. Furthermore, such a system should be capable of leveraging existing cable infrastructure where available, support flexible network topologies including daisy-chain configurations, and provide integrated power distribution to eliminate separate power wiring.

### FIELD OF THE INVENTION

The present invention is directed to a communication and power distribution system utilizing confined RF transmission through conductive media for industrial, robotic, and networked applications.

### BRIEF SUMMARY OF THE INVENTION

It is an objective of the present invention to provide a communication and power distribution system utilizing confined RF transmission through conductive media for industrial, robotic, and networked applications, as specified in the independent claims. Embodiments of the invention are given in the dependent claims. Embodiments of the present invention can be freely combined with each other if they are not mutually exclusive.

The present invention features a data communication system. The system may comprise a hub device configured to generate an outgoing data signal and a power, and receive an incoming data signal. The system may further comprise a transmission line operatively coupled to the hub device, configured to transmit the outgoing data signal, the incoming data signal, and the power simultaneously. The system may further comprise a plurality of devices operatively coupled along the transmission line in a daisy chain configuration such that an amount of power is delivered to each device, each device comprising a data transceiver configured to transmit an amount of the incoming data signal and receive an amount of the outgoing data signal. For the sake of simplicity, this disclosure uses data signal to mean the signal produced by the RF transceiver, e.g., an RF signal such as WiFi or similar, and transmitted over a wire by way of the invention, or transmitted over both wire and wireless in some embodiments.

The present invention features a novel approach to industrial communication infrastructure that repurposes established wireless communication protocols-including but not limited to IEEE 802.11 (WiFi), Bluetooth Low Energy (BLE), IEEE 802. 15.4 (Zigbee (IEEE 802.15.4)/Thread), and other RF-based protocols—for transmission through coaxial cable infrastructure in a daisy-chain topology. This architecture fundamentally transforms these protocols from their traditional omnidirectional, interference-prone wireless implementations into directed, secure, and deterministic wired communication channels while maintaining their inherent advantages of low cost, widespread availability, and mature TCP/IP stack integration.

For industrial IoT sensing applications, particularly in electromagnetically hostile environments and high security zones, the present invention provides several critical advantages, such as electromagnetic isolation. The coaxial shield provides inherent EMI/RFI protection, eliminating the interference susceptibility that plagues traditional wireless deployments in industrial settings with heavy machinery, variable frequency drives, and other electromagnetic noise sources. Furthermore, unlike airborne wireless systems subject to multipath fading, interference, and unpredictable propagation conditions, the present invention delivers consistent, calculable signal propagation characteristics essential for mission-critical industrial monitoring applications. The physical containment of data signals within the coaxial medium eliminates the primary attack vector of wireless systems-over-the-air interception and injection. This physical layer security is particularly valuable in sensitive industrial installations where data exfiltration risks must be minimized. The sophisticated modulation schemes inherent to modern WiFi implementations, particularly OFDM (Orthogonal Frequency Division Multiplexing), enable multiple independent communication channels through frequency multiplexing on a single coaxial conductor. This enables logical segmentation of different sensor types, security zones, or functional domains without additional cabling infrastructure.

When using the WiFi protocol, the present invention maintains full compatibility with standard WiFi medium access control (MAC) protocols, including CSMA/CA (Carrier Sense Multiple Access with Collision Avoidance), without modification (common hardware adaptations are sometimes needed, however, to support impedance matching and power management). From the perspective of the MAC layer and above, the coaxial transmission medium appears functionally identical to free-space wireless propagation. Each device's transceiver operates using commercially available WiFi chipsets running standard firmware and drivers, performing carrier sensing, collision avoidance, and acknowledgment protocols typical of conventional wireless deployments. This preservation of the complete protocol stack—from physical layer modulation through TCP/IP networking-ensures seamless integration with existing WiFi-enabled devices, standard network management tools, and security frameworks (WPA2, WPA3), while eliminating the need for specialized protocol development or non-standard communication stacks. The confined propagation environment actually enhances MAC efficiency by eliminating hidden node problems and reducing collision probability compared to omnidirectional wireless deployments, as all devices share a common, deterministic propagation medium with predictable signal strength characteristics.

One of the unique and inventive technical features of the present invention is the implementation of wireless transceiver devices disposed along a coaxial cable for RF over coax data transmission and reception. Without wishing to limit the invention to any theory or mechanism, it is believed that the technical feature of the present invention advantageously provides for increased directionality and security in the transmission and reception of data in an environment. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skills in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1A shows a schematic diagram of the data communication system with RF over coax communication capabilities of the present invention.

FIG. 1B shows a schematic diagram of data transceiver devices coupled along the coaxial cable of the data communication system of the present invention.

FIGS. 2A-2B show embodiments of a capacitive/inductive coupling assembly implemented in the present invention.

### DETAILED DESCRIPTION OF THE INVENTION

Following is a list of elements corresponding to a particular element referred to herein:
100 system
110 hub device
120 transmission line
130 devices
132 data transceiver
135 device
140 couplers
145 coupler
150 blocking components
155 blocking component
160 bypass conductive paths
165 bypass conductive path
170 low-pass filters
175 low-pass filter
200 rotary joint assembly
205 air gap
206 rotary element
207 power extraction network
208 blocking component
209 power transfer network
210 data coupler

Herein, the terms “power” and “power signal” are used interchangeably. While these terms are similar, these terms have distinct definitions. Power is a simple current, typically DC, that may fluctuate inadvertently or due to noise. A power signal, on the other hand, is power with a modulated waveform having a defined frequency and amplitude, and can be demodulated (rectified) and used to energize circuits as Direct Current (DC) power.

Herein, the term, “wire”, is not limited to a discrete wire, but includes traces in a circuit board, metalizations or conductive paths associated with integrated circuit topologies.

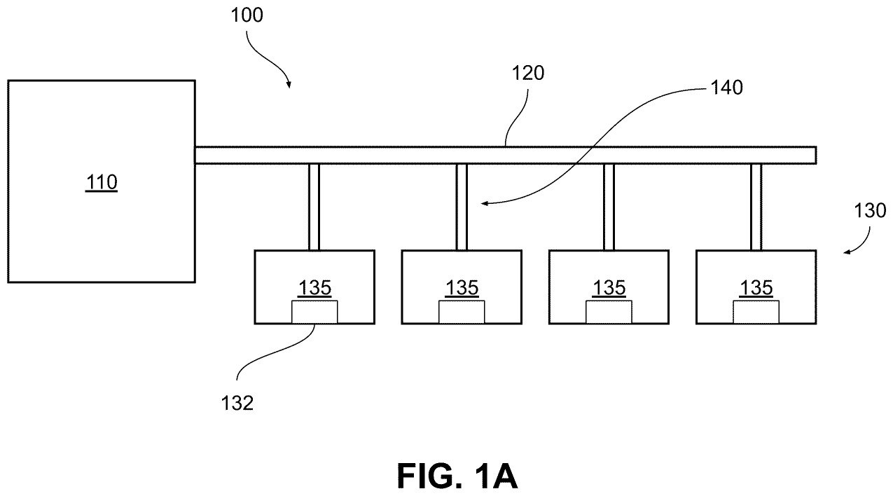

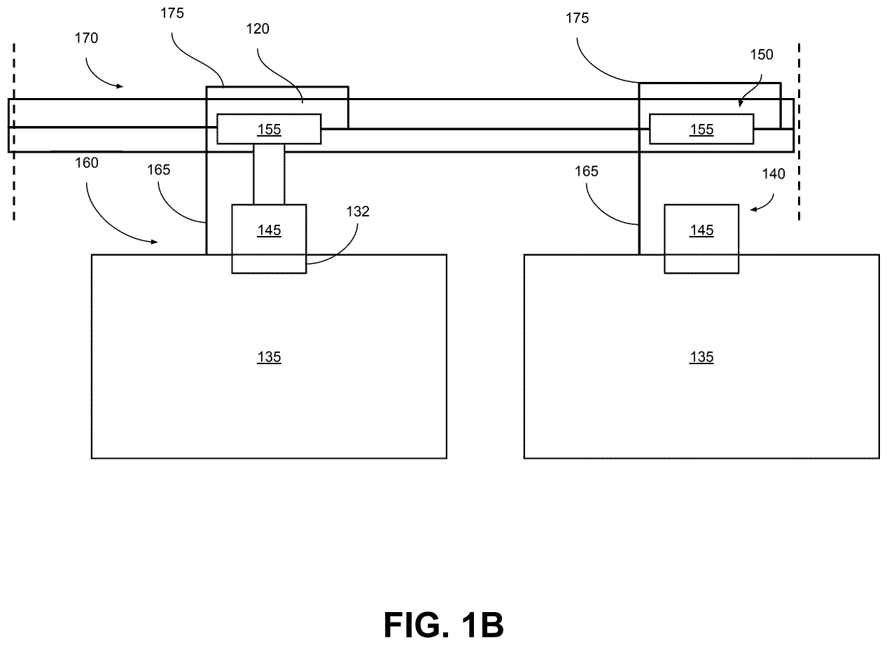

Referring now to FIGS. 1A-1B, the present invention features a data communication system (100). In some embodiments, the system (100) may comprise a hub device (110) configured to generate an outgoing data signal and power, and receive an incoming data signal. The system (100) may further comprise a transmission line (120) operatively coupled to the hub device (110), configured to transmit the outgoing data signal, the incoming data signal, and the power simultaneously. The system (100) may further comprise a plurality of devices (130) operatively coupled along the transmission line (120) in a daisy chain configuration such that an amount of power is delivered to each device (135), each device (135) comprising a data transceiver (132) configured to transmit an amount of the incoming data signal and receive an amount of the outgoing data signal. The amount of power is sufficient to energize the data transceiver.

In some embodiments, in order to mitigate the voltage drop (“IR drop” as it is often described) along the daisy chain, local power conditioning and/or voltage regulation modules may be used at the power extraction point to support any needed voltage drops introduced by finite conductivity of conductors. In the absence of such corrective devices the conductors can be specified such that their conductivity supports the voltage drop requirements of the application.

In some embodiments, the transmission line (120) may comprise a coaxial cable comprising a first conductor disposed along a center of the coaxial cable and a second conductor disposed around a circumference of the coaxial cable. The power may be directed along the first conductor and the second conductor. The data signals propagate as TEM (transverse electromagnetic) waves through the dielectric medium between the center conductor and outer shield. In some embodiments, the outgoing data signal, the incoming data signal, or a combination thereof may comprise a radiofrequency (RF) signal. In some embodiments, the data signal may comprise a WiFi signal, a Zonal Intercommunication Global-standard (ZIGBEE/802.15.4) signal, a Bluetooth Low Energy (BLE) signal, a Near-Field Communication (NFC) signal, or a combination thereof.

In some embodiments, the hub device (110) may comprise a server, a personal computing device, a gateway computing device, or a combination thereof. In some embodiments, the plurality of devices (130) may comprise one or more personal computing devices, one or more mobile computing devices, or a combination thereof. In some embodiments, the outgoing data signal, the incoming data signal, or a combination thereof may be transmitted using a single communication channel. In some embodiments, the outgoing data signal, the incoming data signal, or a combination thereof may be transmitted across a plurality of frequencies through an orthogonal frequency-division multiplexing (OFDM) process.

The present invention features a data communication system (100). In some embodiments, the system (100) may comprise a hub device (110) configured to generate an outgoing data signal and power, and receive an incoming data signal. The system (100) may further comprise a transmission line (120) operatively coupled to the hub device (110), configured to transmit the outgoing data signal, the incoming data signal, and the power simultaneously. The system (100) may further comprise a plurality of devices (130) operatively coupled along the transmission line (120) in a daisy chain configuration such that an amount of power is delivered to each device (135), each device (135) comprising a data transceiver (132) configured to receive an amount of the outgoing data signal and transmit an amount of the incoming data signal. The amount of power is sufficient to energize the data transceiver.

The system (100) may further comprise a plurality of couplers (140) operatively coupled along the transmission line (120) such that each coupler (145) couples a device (135) of the plurality of devices (130) to the transmission line (120), each coupler (145) configured to deliver the amount of the outgoing data signal from the transmission line (120) to the data transceiver (132) of the device (135), match impedance along the transmission line (120) where the coupler (145) is configured to couple the device (135) to the transmission line (120), attenuate the amount of the outgoing data signal delivered to the device (135), and reduce insertion loss accumulated from a presence of the device (135) along the transmission line (120). The system (100) may further comprise a plurality of Direct Current (DC) blocking components (150) operatively coupled along the transmission line (120), each blocking component (155) configured to limit current through the coupler (145) and prevent the power from interfering with an ability of each coupler (145) to deliver the amount of the outgoing data signal to each data transceiver (132) of each device (135). The system (100) may further comprise a plurality of power extraction networks (160) operatively coupled along the transmission line (120), each extraction network (165) configured to direct the amount of power to each device (135), wherein the power is filtered and conditioned so as to be compatible with device electronics including the data transceiver (132). Such a blocking of RF and extraction of DC power is often integrated as a bias tee network component. In order to pass current along the daisy chain, especially when more current is required than can be passed through the coupler, it is necessary to couple the DC power across a device, e.g., across the blocking component (155) using a low-pass filter (175) that accomplishes a low pass filter function so as to enable higher DC current capacity on the transmission line without damaging the directional coupler. In some embodiments where currents are lower, the blocking element (155) and the low-pass filter (175) are not needed, though neither component would necessarily impede operation if included generally.

In some embodiments, the transmission line (120) may comprise a coaxial cable comprising a first conductor disposed along a center of the coaxial cable and a second conductor disposed around a circumference of the coaxial cable. The power is directed along the first conductor and the second conductor. The outgoing data signal, the incoming data signal, or a combination thereof propagate as electromagnetic waves through a dielectric medium disposed between the first conductor and the second conductor. In some embodiments, the plurality of couplers (140) may comprise a plurality of directional couplers, wherein each directional coupler is configured to attenuate the amount of the outgoing data signal delivered to the device (135) in a direction facing the hub device (110). In some embodiments, the plurality of blocking components (150) may comprise a plurality of direct current (DC) blocks. In some embodiments, the outgoing data signal, the incoming data signal, or a combination thereof may comprise a radiofrequency (RF) signal. In some embodiments, the data signal may comprise a WiFi signal, a Zonal Intercommunication Global-standard (ZIGBEE/802.15.4) signal, a Bluetooth Low Energy (BLE) signal, a Near-Field Communication (NFC) signal, or a combination thereof.

The outgoing data signal and the incoming data signal propagate as electromagnetic waves through a dielectric medium disposed between the first conductor and the second conductor. The outgoing data signal and the incoming data signal may propagate as electromagnetic waves through a dielectric medium disposed between the first conductor and the second conductor. The plurality of couplers (140) may comprise a plurality of directional couplers, wherein each directional coupler (145) is oriented to couple signals propagating from the hub device (110) toward the device (135) while providing directional isolation against coupling signals propagating in the opposite direction.

In some embodiments, the hub device (110) may comprise a server, a personal computing device, a gateway computing device, or a combination thereof. In some embodiments, the plurality of devices (130) may comprise one or more personal computing devices, one or more mobile computing devices, or a combination thereof. In some embodiments, the outgoing data signal, the incoming data signal, or a combination thereof may be transmitted across a single frequency. In some embodiments, the outgoing data signal, the incoming data signal, or a combination thereof may be transmitted across a plurality of frequencies through an orthogonal frequency-division multiplexing (OFDM) process.

The present invention features a data communication system (100). The system (100) may comprise a server device (110) configured to generate an outgoing radiofrequency (RF) signal and a power and receive an incoming data signal. The system (100) may further comprise a coaxial cable (120) operatively coupled to the server device (110), configured to transmit the outgoing data signal, the incoming data signal, and the power simultaneously. The system (100) may further comprise a plurality of computing devices (130) operatively coupled along the coaxial cable (120) in a daisy chain configuration such that an amount of power is delivered to each computing device (135), each computing device (135) comprising a RF transceiver (132) configured to receive an amount of the outgoing data signal and transmit an amount of the incoming data signal. The amount of power is sufficient to energize the computing device.

The system (100) may further comprise a plurality of directional couplers (140) operatively coupled along the coaxial cable (120) such that each directional coupler (145) couples a computing device (135) of the plurality of computing devices (130) to the coaxial cable (120), each directional coupler (145) configured to deliver the amount of the outgoing data signal from the coaxial cable (120) to the RF transceiver (132) of the computing device (135), match impedance along the coaxial cable (120) where the directional coupler (145) couples the computing device (135) to the coaxial cable (120), attenuate the amount of the outgoing data signal delivered to the computing device (135) in a direction facing the server device (110), and reduce insertion loss accumulated from a presence of the computing device (135) along the coaxial cable (120). The system (100) may further comprise a plurality of DC blocks (150) operatively coupled along the coaxial cable (120), each DC block (155) configured to limit current through the coupler and prevent the power from interfering with an ability of each directional coupler (145) to deliver the amount of the outgoing data signal to each RF transceiver (132) of each computing device (135). The system (100) may further comprise a plurality of bypass conductive paths (160) operatively coupled along the coaxial cable (120), each bypass conductive path (165) configured to direct the amount of power to each computing device (135). The system (100) may further comprise a plurality of low-pass filters (170) to maximize the available current to devices (130), each low-pass filter (175) connecting across the insertion point of the invention. In some embodiments, the outgoing data signal, the incoming data signal, or a combination thereof may comprise a WiFi signal, a Zonal Intercommunication Global-standard (ZIGBEE/802.15.4) signal, or a combination thereof.

In some embodiments, the couplers may comprise directional couplers. In some embodiments, the blocking components may comprise discrete inductors or equivalent low pass RF elements that pass the DC element while presenting a high impedance to the RF (signal) element of the energy along the transmission line.

The architecture of the present invention supports flexible deployment topologies. The present invention features pure coaxial transmission for maximum security and reliability, and optional antenna termination at chain endpoints for localized wireless coverage within electromagnetically isolated enclosures, enabling hybrid RF over coax topologies where beneficial. The present invention additionally implements standard 50Ω or 75Ω termination at the final node, which ensures optimal signal integrity and minimizes reflections.

The present invention positions industrial Internet of Things (IoT) sensing systems, particularly thermal imaging arrays for electrical equipment monitoring in mining operations (such as switchgear and rectifier systems in solvent extraction and electrowinning (SX/EW) processes), with unique competitive advantages. The present invention leverages mass-produced WiFi/Bluetooth Low Energy (BLE) chipsets rather than specialized industrial protocols, dramatically reducing per-node costs. The present invention provides orders of magnitude more bandwidth than traditional industrial protocols (CANBUS, RS422, etc.), enabling high-resolution thermal imaging and real-time streaming. The present invention provides standards compatibility. The native internet protocol suite (TCP/IP) stack integration simplifies system integration and enables use of standard networking tools and security protocols. The present invention implements a daisy-chain topology with power provisioning simplifies installation and reduces cabling complexity compared to star topologies. As wireless standards evolve (WiFi 6, 6E, 7), the same coaxial infrastructure can support upgraded protocols without rewiring. This implementation thereby creates a defensible competitive moat for industrial IoT sensing deployments, particularly in the demanding environments characteristic of mining, oil & gas, and heavy industrial applications where traditional wireless solutions fail to meet reliability, security, and performance requirements.

In some embodiments, the present architecture extends beyond static industrial sensor networks to encompass dynamic articulated systems requiring signal and power transmission across mechanical interfaces, including but not limited to robotic manipulators, rotating machinery, gimbal systems, turret assemblies, and other mechatronic systems with multiple degrees of freedom. These implementations leverage the fundamental principle of RF over coax while adapting the power delivery architecture to accommodate the unique challenges of maintaining electrical continuity across moving interfaces.

The system enables reliable high-bandwidth communication across critical mechanical interfaces. Non-optical data coupling can be capacitive (plates) or inductive (loops) in nature, as the environment (e.g., highly metallic/magnetic environments) may favor one over the other. In rotating machinery applications, signals in the present invention traverse rotor-stator air gaps through capacitive or inductive RF coupling structures integrated into the mechanical assembly. The RF tap architecture is modified to incorporate split-core transformer geometries or capacitive coupling plates that maintain signal integrity across the air gap while accommodating continuous rotation. The coaxial shield continuity is maintained through the mechanical structure itself, providing a return path that preserves signal containment and EMI immunity. Traditional slip rings, with their inherent wear, maintenance requirements, and bandwidth limitations, can be augmented or replaced entirely with contactless wireless coupling. When slip rings are retained for power transmission, the data signals can be capacitively coupled across the rotating interface in parallel, eliminating the noise and intermittent connectivity issues that plague high-frequency signal transmission through mechanical brush contacts.

Robotic systems with sequential joints—such as 6-Degree-of-Freedom industrial robots, surgical manipulators, or aerospace gimbals—may implement the present invention as a continuous communication backbone that threads through each articulation point. Each joint may comprise specialized RF taps designed into the joint structure that maintain signal continuity through the full range of motion, flexible or semi-rigid coaxial sections between rigid segments, allowing for cable management during articulation, and node controllers at each joint for local motor control, encoder feedback, and sensor integration.

The power distribution strategy adapts to the mechanical constraints of robotic systems through multiple innovative approaches. Rather than pure DC power distribution, the system implements AC power transmission at strategic frequencies (400 Hz to several kHz) that enable efficient transformer-coupled power transfer across air gaps. This approach provides several advantages. The AC power inductively couples across air gaps using transformer structures integrated into the rotary joints, eliminating the need for physical electrical contact while maintaining power transfer efficiency. The baseband AC frequency is selected to balance several factors. It is high enough to enable compact transformer designs with small core volumes, and low enough to minimize skin effect losses in the coaxial conductors. It is strategically placed to avoid interference with the RF communication bands and optimized for the specific gap distances and coupling geometries of the mechanical system.

The system supports simultaneous transmission of multiple power modalities, such as traditional DC power for nodes that don't require gap crossing, AC baseband power for transformer-coupled power transfer across mechanical interfaces, and optional RF power harvesting from the communication signal itself for ultra-low power sensors. The coaxial medium simultaneously carries a sub-1 MHz AC power transmission band (e.g., 400 Hz-100 kHz), 1-10 MHz for optional intermediate frequency control signals, 2.4 GHz/5 GHZ/6 GHz for WiFi/BLE communication bands, and DC-100 Hz for optional DC power with low-frequency telemetry. Each domain is separated using appropriate filtering. High-pass filters (series capacitors) are used to block AC/DC power from RF transceivers. Low-pass filters (series inductors) are used to prevent RF from entering power supplies. Band-pass filters are used to isolate specific AC power frequencies for transformer coupling. Bias tees are used to combine/separate DC, AC, and RF at each node.

The frequency bands for power and communication can be strategically selected and rigorously isolated to prevent mutual interference. AC power transmission, when employed for transformer-coupled power transfer across mechanical interfaces, can operate in a baseband frequency range from approximately 400 Hz to 5 MHz, with typical implementations utilizing frequencies between 20 KHz and 2 MHz. This range provides an optimal balance: sufficiently high frequency to enable compact, efficient transformer designs with minimal core volume, while remaining low enough to minimize skin effect losses in the coaxial conductors and maintain clear separation from RF communication bands. The RF communication signals occupy standard WiFi bands at 2.4 GHZ, 5 GHZ, and 6 GHZ (WiFi 6E), providing a guard band several orders of magnitude between the highest power frequency and the lowest communication frequency. This spectral separation can be maintained through complementary filtering at each node interface. High-pass filters with cutoff frequencies of 50-100 MHz, for example, are implemented in series with RF transceivers, presenting high impedance (<0.5 dB insertion loss) to communication signals while blocking AC and DC power components with greater than 40 dB attenuation. Conversely, low-pass filters with cutoff frequencies of 10-20 MHz can be implemented in power interfaces, efficiently passing power frequencies while attenuating data signals by greater than 40 dB. Bias tees or diplexer structures combine and separate these frequency domains at each node connection point. DC power distribution, when used alongside or instead of AC power, occupies the lowest baseband frequencies, e.g., 0 Hz to approximately 100 Hz, and is similarly isolated from data signals through the same high-pass filtering topology. This multi-domain frequency allocation enables simultaneous, interference-free transmission of DC power, AC power for contactless coupling, and multi-gigabit RF communication on a single coaxial conductor.

The present invention uses a bias tee (or equivalent) structure to separate power from signal. A directional coupler with attenuation is often a design element. Since directional couplers can have insertion losses from approximately 0.3 dB to 3 dB, it is assumed that a component with low enough insertion loss is chosen during electronic design to enable the daisy chain scheme to sustain adequate signal levels (in practice we find that <1 dB of loss is readily available for useful coupling/attenuation).

The high bandwidth and low latency of the present invention enables real-time control applications previously impossible with traditional industrial protocols, such as deterministic motor control. Each joint's motor controller receives commands and transmits feedback over the backbone with latencies suitable for closed-loop servo control at kHz update rates, coordinated multi-axis motion with microsecond-level synchronization, real-time force/torque feedback for haptic applications, and vision-guided servo operations with high-bandwidth image data. The daisy chain architecture supports heterogeneous sensor arrays throughout the articulated structure. The architecture may comprise encoders at each joint for position feedback, Inertial Measurement Units (IMUs) for dynamic state estimation, force/torque sensors for interaction control, temperature sensors for thermal management, proximity sensors for collision avoidance, vision sensors for perception and navigation, or a combination thereof. The protocol implemented by the present invention may incorporate IEEE 1588 Precision Time Protocol or similar synchronization mechanisms, enabling coordinated control across all joints with nanosecond-level time alignment.

The present invention may implement a plurality of mechanical integration strategies. In robotic designs with hollow shaft motors, the coaxial cable may route through the center of rotation, with rotary transformers or capacitive couplers integrated into the shaft assembly for both power and signal transfer. For solid shaft designs, concentric coupling rings around the shaft perimeter may provide capacitive or inductive coupling paths for signals and AC power, with the mechanical structure providing shield continuity. At points of limited articulation (±180° or less), flexible coaxial circuits integrated into the joint structure may eliminate the need for contactless coupling while maintaining full communication functionality.

The present invention may be optimized for different applications. For surgical robotics applications, the present invention may implement ultra-low noise operation with galvanic isolation between joints for patient safety, using transformer-coupled AC power and capacitively coupled data signals. For industrial automation applications, high power delivery may be implemented through larger coaxial conductors with robust coupling structures, e.g., the use of high conductivity inductors across daisy chain connection points in order to extend typical directional coupler current limits, designed for millions of cycles without maintenance. For aerospace/defense applications, the present invention may comprise radiation-hardened implementations with redundant coupling paths and a frequency-hopping spread spectrum for jamming resistance. For subsea robotics applications, the present invention may comprise pressure-compensated coupling structures with sealed coaxial segments between joints, enabling operation at extreme depths while maintaining signal integrity.

The present invention may provide transformative benefits for robotic systems. The present invention may comprise a simplified wiring harness. A single coaxial cable may replace complex multi-conductor bundles. Contactless coupling may eliminate wear-prone slip rings and connectors. True continuous rotation capability may be implemented without cable wrap limitations. The present invention may further implement EMI Immunity, which is critical for operation in industrial environments with welding, motors, and switching power supplies. The scalable bandwidth may support everything from simple limit switches to 4K video streams. Transformer coupling may achieve 90% or greater efficiency across air gaps. Joints can be added/removed from the daisy chain without rewiring. Inherent galvanic isolation between segments may enhance safety in human-robot interaction. This comprehensive implementation thereby enables a new generation of robotic and articulated systems with unprecedented integration density, reliability, and performance, while maintaining the cost advantages of leveraging mass-produced wireless communication chipsets in a novel wired configuration.

Each node may implement disparate protocol pairs, one for the coaxial backbone, another for local wireless communication. For backbone optimization, the coaxial medium may carries WiFi (high bandwidth, TCP/IP native) for efficient backbone communication, while endpoints translate to BLE for low-power sensor networks in each room, Zigbee (IEEE 802.15.4)/Thread for mesh networking with smart home devices, Near-Field Communication (NFC) for proximity-based authentication and configuration, and custom protocols for specialized equipment. Furthermore, the present invention features security measures through protocol isolation. Devices speaking BLE in a room cannot directly access or even detect the WiFi backbone in the coax. A compromised BLE device has no mechanism to attack the WiFi infrastructure since it lacks the physical layer capability to interact with it. This creates an inherent security boundary at the protocol level-far stronger than Virtual Local Area Network (VLAN) or software-based segmentation.

The present invention may be further applied to smart home security zones. The backbone may run WPA3-Enterprise WiFi through household coaxial cables. Bedroom endpoints may translate to BLE for fitness trackers and sleep monitors. The kitchen endpoint may translate to Zigbee (IEEE 802.15.4) for appliances that only speak that protocol. The garage endpoint may maintain WiFi for high-bandwidth security cameras. Each zone's devices may only speak their local protocol, physically unable to cross-communicate without explicit bridging rules.

The present invention may be further applied to industrial sensor networks. The backbone may operate on 5 GHz WiFi for interference immunity. Equipment monitoring points translate to BLE for battery-powered vibration sensors. Critical control points may maintain WiFi for real-time streaming. Handheld diagnostic tools may use BLE to connect locally, with their traffic translated to WiFi for backbone transmission. A technician's BLE scanner may never see the WiFi network, enhancing security.

The present invention may be further applied to healthcare environments. The backbone may run medical-grade secured WiFi through hospital coaxial infrastructure. Patient rooms may translate to BLE for medical devices (pulse oximeters, glucose monitors). Operating theaters may translate to proprietary 2.4 GHz protocols for surgical equipment. Nursing stations may maintain WiFi for workstations and tablets. Medical devices using BLE may not interfere with or access critical WiFi infrastructure.

The protocol translation can help obscure device identity from the backbone network, such translation allowing for the differences in time, data rates, packet structures and QoS mechanisms so as to support effective communication within the limits of such translation. A smart TV broadcasting its presence via BLE in a room appears on the backbone as WiFi traffic from the translator node, not as the original device. This defeats MAC address tracking across the network, device fingerprinting by traffic analysis, and direct device-to-device discovery and potential lateral movement attacks. The protocol translator can act as a selective gateway. BLE devices in a room can communicate locally with each other, but only specific, whitelisted data patterns get translated to WiFi for internet access. Telemetry and phone-home attempts may be identified and blocked at the translation layer. The device may continue functioning locally via BLE while being effectively air-gapped from the internet. Guest networks may additionally benefit from the present invention. Visitors' phones may connect via BLE to a guest endpoint, while the translator provides internet access over the WiFi backbone. Guests never receive WiFi credentials or access to the WiFi network, and complete isolation is maintained since their devices physically cannot speak WiFi to attack the backbone.

As stated above, robotic systems may be enhanced by the protocol translation functionality of the present invention. For multi-protocol robotic control, the backbone may run industrial Ethernet protocols over WiFi through the robot's coaxial harness. Joint motor controllers may receive high-speed commands via the WiFi backbone. Each joint may further comprise a BLE breakout for local wireless sensors (temperature, vibration, proximity). Maintenance tools may connect via BLE at any joint without accessing the critical control network. Vision sensors may stream over WiFi while battery-powered safety sensors use BLE. For collaborative robot (Cobot) safety, safety-critical control may run on isolated WiFi through the present invention. Workers may wear BLE beacons for proximity detection. Each robot joint may translate BLE beacon signals to safety commands on the WiFi backbone. Workers' devices may not access or interfere with robot control networks.

The present invention may further improve the functionality of consumer products. For modular home entertainment, the central receiver may implement the present invention to distribute high-bandwidth audio/video over existing coaxial cables. Each room's endpoint may translate to appropriate protocols, such as BLE for headphones and portable speakers, WiFi for streaming devices requiring high bandwidth, a 2.4 GHz protocol for gaming controllers, and infrared (IR) translation for legacy devices. A single coax cable may replace multiple wireless systems while maintaining compatibility.

For retrofitting smart home gateways, existing coaxial outlets may become universal smart home adapters. The present invention may carry WiFi through existing cable TV coaxial cables. Each outlet may translate to whatever protocol local devices require. Legacy Zigbee (IEEE 802.15.4) devices, new Thread devices, and proprietary protocols may all coexist, and the homeowner never needs to know or care about protocol differences.

For voice assistant networks, the backbone may keep voice data on segregated WiFi. Room endpoints may translate to BLE for local wake word detection. Only confirmed commands may travel the WiFi backbone to a local processing server, and the voice may never leave the home network in raw form. BLE devices in rooms cannot access other rooms' conversations.

In some embodiments, endpoints may intelligently select output protocols based on device discovery (detecting what protocols nearby devices support), power availability (BLE for battery operation, WiFi for powered devices), bandwidth requirements (auto-upgrading to WiFi for streaming), and security context (forcing high-security zones to use encrypted protocols). Single endpoints may simultaneously support multiple wireless protocols, such as WiFi on 5 GHz for streaming devices, BLE on 2.4 GHz for sensors, and sub-GHz protocols for long-range IoT, all multiplexed onto the single backbone. Endpoints may time-slice between protocols, such as BLE during normal operation for power efficiency, WiFi burst mode for periodic high-speed data dumps, and emergency override to dedicated protocol during alarm conditions. This protocol translation capability fundamentally transforms the present invention from a simple “wireless over wire” technology into a comprehensive protocol abstraction layer that provides unprecedented flexibility, security, and compatibility in both industrial and consumer applications. The ability to maintain disparate protocols-one in the coax, another in the air-creates natural security boundaries while solving real-world compatibility challenges that plague current IoT and smart home deployments.

In some embodiments, the present invention features an articulated robotic communication and power system (100). The system (100) may comprise a) a hub device (110) configured to generate an outgoing radiofrequency (RF) signal, an alternating current (AC) power, and receive an incoming data signal. The system may further comprise a flexible transmission line (120) operatively coupled to the hub device (110) and threaded through a plurality of articulating joints, configured to transmit the outgoing data signal, the incoming data signal, and the AC power simultaneously. The system may further comprise a plurality of joint node devices (130) operatively coupled along the transmission line (120) at each articulating joint. Each joint node device (135) may comprise an RF coupling structure configured to transfer the outgoing data signal and the incoming data signal across a mechanical interface of the articulating joint. Each joint node device (135) may further comprise a transformer coupling structure configured to transfer the AC power across an air gap at the mechanical interface without physical electrical contact. Each joint node device (135) may further comprise a control module configured to receive power from the AC power and communicate via the data signals. The RF coupling structure and the transformer coupling structure may operate in separate frequency bands with a frequency separation of more than an order of magnitude. Failure of any joint node device (135) may not interrupt signal propagation to remaining joint node devices along the transmission line (120).

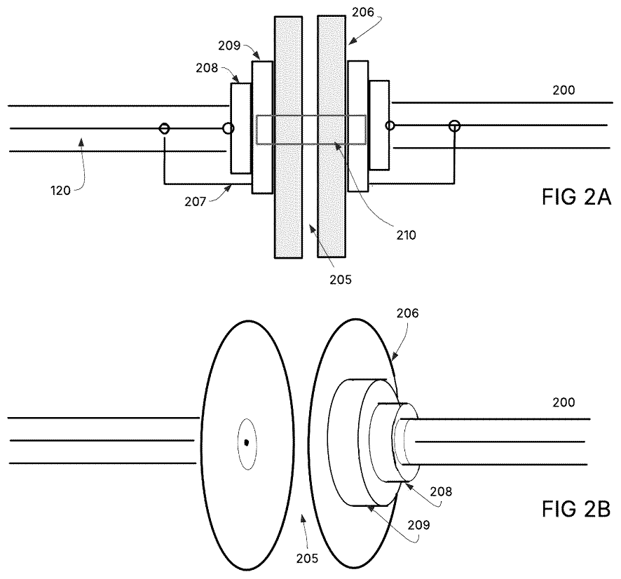

In some embodiments, the RF coupling structure may comprise a capacitive coupling assembly or an inductive coupling assembly configured to transfer data signals across a rotating interface without physical contact. FIGS. 2A-2B illustrate the extension of FIGS. 1A-1B to a rotary joint, such as if the transmission line (120) extended beyond a device (135) daisy chain to include a rotary joint.

With reference to FIGS. 2A-2B the transmission line (120) may couple AC or DC power from the center conductor to a power extraction network (207) that directs energy to a power transfer network (209) that produces (in the case of DC coupled power) a power form and frequency suitable for coupling across an air gap (205) or directly relays (in the case of AC coupled power) a power form and frequency suitable for coupling across an air gap (205). The power transfer network (209) may be integrated into or alongside the rotary element (206). A similar rotary element (206), power transfer network (209) and power extraction network can be found on each side of the rotary joint, similar to symmetry found for the daisy chain devices (135), the rotary joint behaving topologically similar to a device node. FIG. 2B shows an embodiment of a rotary joint having the invention in which its elements are located concentrically about the transmission line (120), terminating on the rotary element (206) itself. The power transfer network can be a custom element or a commercially available air gapped transformer, or a capacitively coupled structure that is often used in rotary power transfer schemes. The data signal is transferred across the air gap by a data coupler (210) that couples data energy across the air gap (205) using an inductive, capacitive or photonic (e.g., RF to optical) element suited to the air gap size, material and geometry, it being understood that a companion energy coupling occurs on the other side of the air gap (205) where a companion rotary element (206) lies.

In some embodiments, the AC power may operate at a frequency of 400 Hz to 5 MHz, and wherein the outgoing data signal and incoming data signal operate at frequencies of 2 GHz or above. In some embodiments, the transformer coupling structure may comprise a split-core transformer geometry integrated into a rotary joint assembly, configured to maintain power transfer efficiency above 80% across an air gap of 0.5 mm to 5 mm during continuous rotation. In some embodiments, each joint node device (135) may further comprise a high-pass filter with a cutoff frequency between 50 MHz and 100 MHz, operatively coupled to the RF coupling structure, configured to pass the outgoing data signal and the incoming data signal while attenuating the AC power by at least 40 dB. Each joint node device (135) may further comprise a low-pass filter with a cutoff frequency between 10 MHz and 20 MHz, operatively coupled to the transformer coupling structure, configured to pass the AC power while attenuating the outgoing data signal and the incoming data signal by at least 40 dB.

In some embodiments, the articulating joints may comprise at least one of: a rotary joint with unlimited rotation capability, a gimbal joint, a prismatic joint, or a revolute joint with limited angular range. In some embodiments, each joint node device (135) may further comprise one or more sensors selected from the group consisting of: rotary encoders, inertial measurement units (IMUs), force sensors, torque sensors, temperature sensors, proximity sensors, and vision sensors, wherein sensor data is transmitted via the incoming data signal. In some embodiments, the control module may be configured to receive motor control commands via the outgoing data signal and provide real-time feedback via the incoming data signal with latency suitable for closed-loop servo control at update rates exceeding 1 kHz. In some embodiments, the transmission line (120) may comprise rigid coaxial segments within structural members between joints and flexible coaxial segments at articulation points, configured to accommodate joint motion through a specified range of motion without cable fatigue failure.

The present invention features a method of transmitting power and communication signals through an articulated mechanical system. In some embodiments, the method may comprise generating an outgoing radiofrequency (RF) signal in a first frequency band above 2 GHz and an alternating current (AC) power in a second frequency band below 5 MHz. The method may further comprise transmitting both the outgoing data signal and the AC power simultaneously through a coaxial transmission line threaded through a plurality of articulating joints. The method may further comprise, at each articulating joint, contactlessly coupling the outgoing data signal across a mechanical interface using a capacitive or inductive RF coupling structure. The method may further comprise, at each articulating joint, contactlessly transferring the AC power across an air gap using a transformer coupling structure. The method may further comprise filtering the outgoing data signal and the AC power at each joint using complementary high-pass and low-pass filters to maintain isolation exceeding 40 dB between frequency bands. The method may further comprise maintaining signal propagation continuity along the coaxial transmission line through passive coupling structures such that failure of any individual joint node does not interrupt communication to remaining joint nodes.

The present invention features a multi-protocol communication system (100). The system (100) may comprise a hub device (110) configured to generate an outgoing data signal in a first communication protocol and receive an incoming data signal in the first communication protocol. The system (100) may further comprise a transmission line (120) operatively coupled to the hub device (110), configured to transmit the outgoing data signal and the incoming data signal in the first communication protocol. The system (100) may further comprise a plurality of protocol translation nodes (130) operatively coupled along the transmission line (120) in a daisy chain configuration. Each protocol translation node (135) may comprise a first transceiver configured to communicate via the transmission line (120) using the first communication protocol. Each protocol translation node (135) may further comprise a second transceiver configured to communicate wirelessly via free-space propagation using a second communication protocol different from the first communication protocol. Each protocol translation node (135) may further comprise a protocol bridge processor configured to selectively translate data between the first communication protocol and the second communication protocol. The first communication protocol and the second communication protocol may operate on incompatible physical layer specifications such that devices configured to communicate using the second communication protocol are physically unable to directly access signals on the transmission line (120).

In some embodiments, the first communication protocol may comprise WiFi (IEEE 802.11). The second communication protocol may comprise at least one protocol selected from the group consisting of: Bluetooth Low Energy (BLE), Zigbee (IEEE 802.15.4), Thread, Near-Field Communication (NFC), Z-Wave, and proprietary 2.4 GHz protocols. In some embodiments, different protocol translation nodes (135) may implement different second communication protocols, such that a first protocol translation node communicates locally via Bluetooth Low Energy (BLE) while a second protocol translation node communicates locally via Zigbee (IEEE 802.15.4). In some embodiments, the protocol bridge processor may configured to implement security policies comprising whitelisting specific device identifiers authorized to communicate through the protocol translation node, blocking predefined data patterns associated with unauthorized telemetry or phone-home attempts, and permitting local device-to-device communication via the second communication protocol while preventing internet access for selected devices.

In some embodiments, the protocol bridge processor may obscure device identity by presenting wireless devices communicating via the second communication protocol as traffic originating from the protocol translation node (135) on the transmission line (120), thereby preventing MAC address tracking and device fingerprinting across the transmission line network. In some embodiments, at least one protocol translation node (135) may comprise a plurality of second transceivers, each configured to communicate using a different communication protocol. The protocol bridge processor may be configured to simultaneously support communication via the plurality of different communication protocols. In some embodiments, the protocol bridge processor may be configured to operate the plurality of second transceivers in a time-sliced mode comprising a low-power protocol mode for continuous operation, a high-bandwidth protocol mode activated periodically for data burst transmission, and an emergency protocol mode activated in response to alarm conditions. In some embodiments, the protocol bridge processor may implement frequency isolation by operating the first communication protocol on a 5 GHz frequency band via the transmission line (120) and operating the second communication protocol on a 2.4 GHz frequency band via free-space propagation. The frequency separation may prevent mutual interference between communication domains.

In some embodiments, the transmission line (120) may comprise a coaxial cable, and signals in the first communication protocol may be confined within the coaxial cable, providing electromagnetic isolation from free-space propagation of the second communication protocol. In some embodiments, the system (100) may further comprise a power distribution system configured to deliver electrical current through the transmission line (120) to each protocol translation node (135). Each protocol translation node (135) may be configured to power both the first transceiver and the second transceiver from the electrical current. In some embodiments, at least one joint node device (135) may further comprise a second transceiver configured to communicate wirelessly via free-space propagation using a communication protocol different from the data signal protocol. At least one joint node device (135) may further comprise a protocol bridge processor configured to selectively translate data between the data signal and the second transceiver communication protocol. Local sensors or devices may communicate with the joint node device via the second transceiver while control commands and telemetry are transmitted through the transmission line (120) via the data signal.

The present invention features a smart home communication system (100). The system (100) may comprise a hub device (110) configured to generate an outgoing WiFi signal and receive an incoming WiFi signal, operatively coupled to an internet gateway. The system (100) may further comprise a coaxial cable network (120) installed throughout a residential structure, configured to transmit the outgoing WiFi signal and the incoming WiFi signal. The system (100) may further comprise a plurality of room-specific protocol translation nodes (130) coupled to the coaxial cable network (120) at coaxial outlets in different rooms. Each room-specific protocol translation node (135) may comprise a WiFi transceiver configured to communicate via the coaxial cable network (120). Each room-specific protocol translation node (135) may further comprise a local wireless transceiver configured to communicate with smart home devices in the room using a protocol selected from the group consisting of: Bluetooth Low Energy (BLE), Zigbee (IEEE 802.15.4), Thread, and Z-Wave. Each room-specific protocol translation node (135) may further comprise a protocol bridge processor configured to translate commands and data between WiFi and the local wireless protocol. Smart home devices communicating via the local wireless protocol in each room may be unable to directly access or interfere with WiFi signals on the coaxial cable network (120), providing inherent security isolation.

In some embodiments, the protocol bridge processor may be configured to permit local control of smart home devices within a room via the local wireless protocol without requiring internet access, selectively forward device status and sensor data to the hub device (110) via the coaxial cable network (120), and block smart home device attempts to communicate with external servers except for explicitly authorized services.

The present invention features an industrial sensor network system (100). The system (100) may comprise a hub device (110) configured to generate an outgoing industrial-grade WiFi signal operating on a 5 GHz frequency band. The system (100) may further comprise a coaxial cable backbone (120) installed throughout an industrial facility, configured to transmit the outgoing WiFi signal with electromagnetic interference (EMI) immunity. The system (100) may further comprise a plurality of equipment monitoring nodes (130) coupled to the coaxial cable backbone (120) at machinery locations. Each equipment monitoring node (135) may comprise a WiFi transceiver configured to communicate via the coaxial cable backbone (120). Each equipment monitoring node (135) may further comprise a Bluetooth Low Energy (BLE) transceiver configured to communicate with battery-powered wireless sensors. Each equipment monitoring node (135) may further comprise a protocol bridge processor configured to translate sensor data from BLE to WiFi. Battery-powered wireless sensors communicating via BLE may be physically isolated from the WiFi industrial control network, preventing wireless sensors from accessing or interfering with critical control infrastructure.

The present invention features a method of providing secure multi-protocol communication. The method may comprise transmitting data in a first communication protocol through a confined transmission medium comprising a coaxial cable, wherein the first communication protocol signals are electromagnetically contained within the coaxial cable. The method may further comprise at a plurality of translation nodes along the coaxial cable, extracting portions of the data transmitted in the first communication protocol. The method may further comprise converting the extracted data from the first communication protocol to a second communication protocol that is physically incompatible with the first communication protocol. The method may further comprise wirelessly transmitting the converted data via free-space propagation using the second communication protocol to local devices within range of each translation node. The method may further comprise receiving response data from the local devices via the second communication protocol. The method may further comprise selectively filtering the response data based on security policies comprising device whitelists and data pattern blacklists. The method may further comprise converting filtered response data from the second communication protocol to the first communication protocol. The method may further comprise transmitting the converted response data through the coaxial cable to a hub device. The physical incompatibility between the first and second communication protocols may prevent local devices from directly accessing signals in the coaxial cable. The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). The size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires (conductive paths), input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer-readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object-oriented programming language such as Java, Smalltalk, C #, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft® NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft® Corporation; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A data communication system (100) comprising:
a) a hub device (110) configured to generate an outgoing data signal and power, and receive an incoming data signal;
b) a transmission line (120) operatively coupled to the hub device (110), configured to transmit the outgoing data signal, the incoming data signal, and the power simultaneously; and
c) a plurality of devices (130) operatively coupled along the transmission line (120) in a daisy chain configuration such that an amount of power is delivered to each device (135) sufficient to energize the data transceiver, each device (135) comprising a data transceiver (132) configured to receive an amount of the outgoing data signal and transmit an amount of the incoming data signal.

2. The system (100) of claim 1, wherein the transmission line (120) comprises a coaxial cable comprising a first conductor disposed along a center of the coaxial cable and a second conductor disposed around a circumference of the coaxial cable, wherein the power is directed along the first conductor and the second conductor, wherein the outgoing data signal and the incoming data signal propagate as electromagnetic waves through a dielectric medium disposed between the first conductor and the second conductor.

3. The system (100) of claim 1, wherein the outgoing data signal, the incoming data signal, or a combination thereof comprise a radiofrequency (RF) signal.

4. The system (100) of claim 3, wherein the data signal comprises a WiFi signal, a Bluetooth Low Energy (BLE) signal, a Near-Field Communication (NFC) signal, or a combination thereof.

5. The system (100) of claim 1, wherein the hub device (110) comprises a server, a personal computing device, a gateway computing device, or a combination thereof.

6. The system (100) of claim 1, wherein the plurality of devices (130) comprise one or more personal computing devices, one or more mobile computing devices, or a combination thereof.

7. The system (100) of claim 1, wherein the outgoing data signal, the incoming data signal, or a combination thereof are transmitted across a single channel.

8. The system (100) of claim 1, wherein the outgoing data signal, the incoming data signal, or a combination thereof are transmitted across a plurality of frequencies through an orthogonal frequency-division multiplexing (OFDM) process.

9. A data communication system (100) comprising:
a) a hub device (110) configured to generate an outgoing data signal and power, and receive an incoming data signal;
b) a transmission line (120) operatively coupled to the hub device (110), configured to transmit the outgoing data signal, the incoming data signal, and the power simultaneously;
c) a plurality of devices (130) operatively coupled along the transmission line (120) in a daisy chain configuration such that an amount of power is delivered to each device (135) sufficient to energize the data transceiver, each device (135) comprising a data transceiver (132) configured to receive an amount of the outgoing data signal and transmit an amount of the incoming data signal;
d) a plurality of couplers (140) operatively coupled along the transmission line (120) such that each coupler (145) couples a device (135) of the plurality of devices (130) to the transmission line (120), each coupler (145) configured to extract a portion of the outgoing data signal from the transmission line (120) and deliver said portion to the data transceiver (132) of the device (135), match impedance along the transmission line (120) where the coupler (145) is configured to couple the device (135) to the transmission line (120), attenuate the amount of the outgoing data signal delivered to the device (135), and reduce insertion loss accumulated from a presence of the device (135) along the transmission line (120);
e) a plurality of Direct Current (DC) blocking components (150) operatively coupled along the transmission line (120), each DC blocking component (155) configured to limit current and prevent the power from interfering with an ability of each coupler (145) to deliver the amount of the outgoing data signal to each data transceiver (132) of each device (135);
f) a plurality of low pass filter elements (170) operatively coupled along the transmission line (120), each low pass filter element (175) configured to pass DC current and maximize power available to each subsequent device (135); and
g) a plurality of bypass conductive paths (160) operatively coupled along the transmission line (120), each bypass conductive path (165) configured to direct the amount of power to the data transceiver (132) of each device (135).

10. The system (100) of claim 9, wherein the transmission line (120) comprises a coaxial cable comprising a first conductor disposed along a center of the coaxial cable and a second conductor disposed around a circumference of the coaxial cable, wherein the power is directed along the first conductor and the second conductor, wherein the outgoing data signal and the incoming data signal propagate as electromagnetic waves through a dielectric medium disposed between the first conductor and the second conductor.

11. The system (100) of claim 9, wherein the plurality of couplers (140) comprise a plurality of directional couplers, wherein each directional coupler (145) is oriented to couple signals propagating from the hub device (110) toward the device (135) while providing directional isolation against coupling signals propagating in the opposite direction.

12. The system (100) of claim 9, wherein the plurality of DC blocking components (150) comprise a plurality of direct current (DC) blocks.

13. The system (100) of claim 9, wherein the outgoing data signal, the incoming data signal, or a combination thereof comprise a radiofrequency (RF) signal.

14. The system (100) of claim 13, wherein the data signal comprises a WiFi signal, a Zonal Intercommunication Global-standard (ZIGBEE/802.15.4) signal, a Bluetooth Low Energy (BLE) signal, a Near-Field Communication (NFC) signal, or a combination thereof.

15. The system (100) of claim 9, wherein the hub device (110) comprises a server, a personal computing device, a gateway computing device, or a combination thereof.

16. The system (100) of claim 9, wherein the plurality of devices (130) comprise one or more personal computing devices, one or more mobile computing devices, or a combination thereof.

17. The system (100) of claim 9, wherein the outgoing data signal, the incoming data signal, or a combination thereof are transmitted across a single frequency.

18. The system (100) of claim 9, wherein the outgoing data signal, the incoming data signal, or a combination thereof are transmitted across a plurality of frequencies through an orthogonal frequency-division multiplexing (OFDM) process.

19. A data communication system (100) comprising:
a) a server device (110) configured to generate an outgoing radio frequency (RF) signal and power and receive an incoming data signal;
b) a coaxial cable (120) operatively coupled to the server device (110), configured to transmit the outgoing data signal, the incoming data signal, and the power simultaneously;
c) a plurality of computing devices (130) operatively coupled along the coaxial cable (120) in a daisy chain configuration such that an amount of power is delivered to each computing device (135) sufficient to energize the computing device, each computing device (135) comprising a RF transceiver (132) configured to receive an amount of the outgoing data signal and transmit an amount of the incoming data signal;
d) a plurality of directional couplers (140) operatively coupled along the coaxial cable (120) such that each directional coupler (145) couples a computing device (135) of the plurality of computing devices (130) to the coaxial cable (120), each directional coupler (145) configured to deliver the amount of the outgoing data signal from the coaxial cable (120) to the RF transceiver (132) of the computing device (135), match impedance along the coaxial cable (120) where the directional coupler (145) couples the computing device (135) to the coaxial cable (120), attenuate the amount of the outgoing data signal delivered to the computing device (135) in a direction facing the server device (110), and reduce insertion loss accumulated from a presence of the computing device (135) along the coaxial cable (120);
e) a plurality of direct current (DC) blocks (150) operatively coupled along the coaxial cable (120), each DC block (155) configured to limit current and prevent the power from interfering with an ability of each directional coupler (145) to deliver the amount of the outgoing data signal to each RF transceiver (132) of each computing device (135);
f) a plurality of low pass filter elements (170) operatively coupled along the transmission line (120), each low pass filter element (175) configured to pass DC current and maximize power available to each subsequent device (135); and
g) a plurality of bypass conductive paths (160) operatively coupled along the coaxial cable (120), each bypass conductive path (165) configured to direct the amount of power to the RF transceiver (132) of each computing device (135).

20. The system (100) of claim 19, wherein the outgoing data signal, the incoming data signal, or a combination thereof comprise a WiFi signal, or a combination thereof.
